(19) United States
(12) Patent Application Publication
(10) Pub. No.: US 2011/0313810 A1
(43) Pub. Date: Dec. 22, 2011

(54) SERVICE TRACKING SYSTEM

(75) Inventors: Eckhard Herzberger, Walldorf (DE); Peter Kranczoch, Obersuelzen (DE); Marika Lemke, Waghaeusel (DE)

(73) Assignee: HEIDELBERGER DRUCKMASCHINEN AKTIENGESELLSCHAFT, Heidelberg (DE)

(21) Appl. No.: 13/155,429

(22) Filed: Jun. 8, 2011

(30) Foreign Application Priority Data
Jun. 18, 2010 (DE) 10 2010 024 275.6

(51) Int. Cl. G06Q 10/00

(52) U.S. Cl. 705/7.24

(57) ABSTRACT

A method for servicing machinery for the graphic arts industry uses at least one remote service computer, which receives a service request for a machine via a first information channel and transforms the service request into a service ticket and which receives operating data of the machine via a second information channel. Accordingly, the operating data are linked with the service ticket in the service computer and the linked data are subjected to a diagnostic fault-finding process by the service computer.

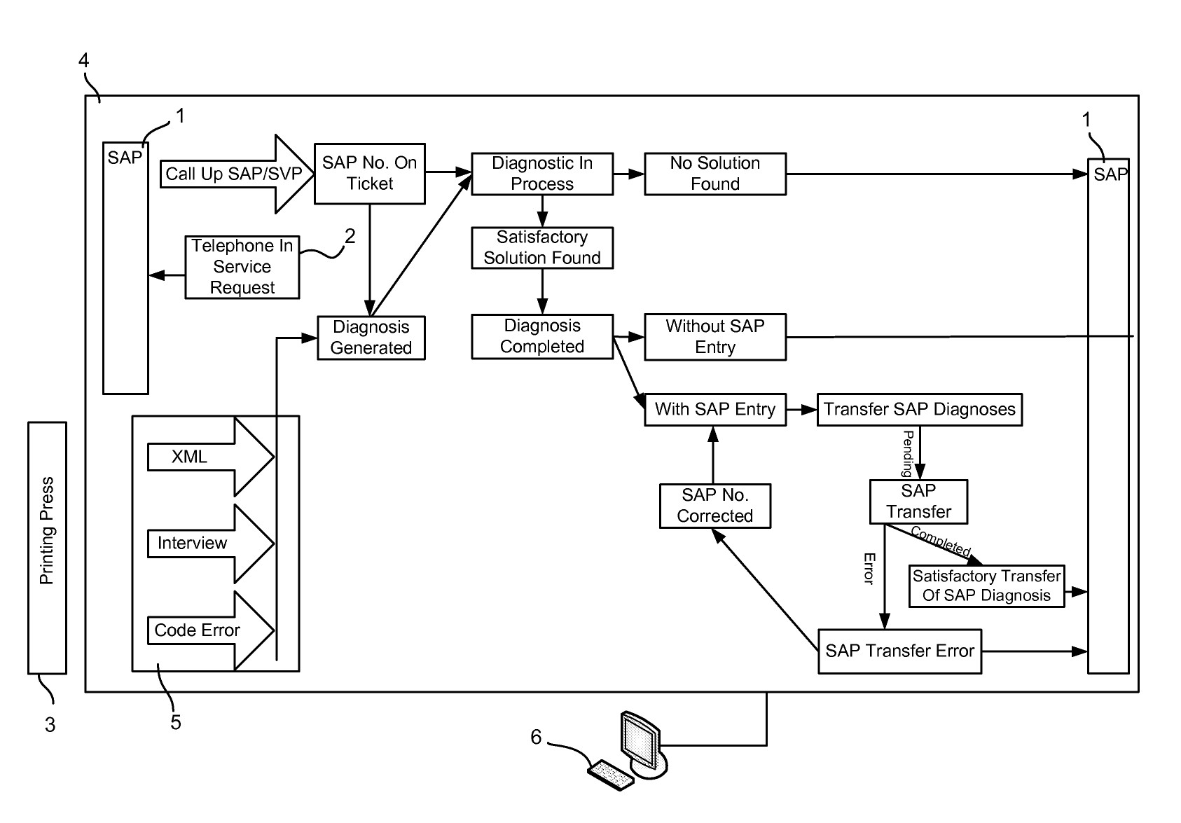

### CROSS-REFERENCE TO RELATED APPLICATION

This application claims the priority, under 35 U.S.C. §119, of German application DE 10 2010 024 275.6, filed Jun. 18, 2010; the prior application is herewith incorporated by reference in its entirety.

### BACKGROUND OF THE INVENTION

### Field of the Invention

The present invention relates to a method of servicing machinery in the graphic arts industry using at least one remote service computer, which receives a service request for a machine via a first information channel and transforms it into a service ticket, and which receives operating data of the machine via a second information channel.

Today, many machines of the graphic arts industry such as printing presses, plate exposure devices, and machines for the further processing of printed products are serviced using a remote service computer. This is a way to reduce the amount of travelling the service staff has to do when there is a problem with a machine. The remote service systems may operate in different ways. For instance, the owner of a press may place a service request with the manufacturer by phone or by pushing a button. On the phone, he may give the machine number and describe the problems that have occurred. Then the manufacturer of the machine may access the control of the press from his remote service computer via an Internet connection to try and solve the problem or to transfer more information from the control of the press to the remote service computer for further analysis. Such a remote service process is disclosed in the published European patent application No. EP 1 855 162 A2, corresponding to U.S. patent publication No. 2007/0266424. In general, what is known as a service ticket is created in the remote service computer in order to be able to track the service operation. This service ticket unequivocally associates the data generated in the course of the service operation with the machine to be serviced and with the relevant service request.

However, the method described above relies on different information channels for the placing of the service request and the request for further operative data of the press. Thus the service request is made on the phone, whereas the operating data of the press are accessed from the remote service computer via the Internet.

### SUMMARY OF THE INVENTION

It is accordingly an object of the invention to provide a service tracking system which overcomes the above-mentioned disadvantages of the prior art methods of this general type.

With the foregoing and other objects in view there is provided, in accordance with the invention a method of servicing machinery in the graphic arts industry. The method includes the steps of: receiving, via at least one remote service computer, a service request for a machine through a first information channel and generating a service ticket from the service request; receiving, at the remote service computer, operating data of the machine via a second information channel; linking the operating data to the service ticket in the remote service computer resulting in linked data; and subjecting the linked data to a diagnostic fault-finding process by means of the remote service computer.

The object of the invention is to provide a method of servicing machinery of the graphic arts industry using at least one remote service computer and ensuring that data received via different information channels are correlated.

In accordance with the invention, a service request that is communicated via a first information channel such as a phone line is computationally linked to operating data that was obtained from the control computer of the machine via a second information channel such as the Internet so that these data are correlated even though they reached the remote service computer via different communication channels and had initially been stored in different systems. The remote service computer then subjects the data that have been correlated in this way to a fault-finding process to troubleshoot the reported problem. The correlation between the operating data and the service ticket may, for instance, be made using the machine number. If the service request is made on the phone, the customer provides the serial number of the machine. This number may then be used to ensure that the operating data of the correct machine are accessed via the Internet and linked to the service ticket. The service ticket may, for instance, be generated in an SAP system. All service tickets may receive consecutive SAP numbers. The requested data of the press are initially stored in a knowledge base and are then correlated with the service ticket. In the process, it is possible to make a fault diagnosis based on the data from the knowledge base and then to make the correlation with the SAP ticket based on the identical serial number of the machine.

In accordance with a first embodiment of the invention, the service ticket may be stored in a service tracking system and once the diagnosis has been made and the service ticket has been successfully processed, an entry including a link to the service ticket may be made in the same service tracking system. The service tracking system is preferably an SAP system. Both the service ticket and the tracking of the service operations following the diagnosis or successful processing may be stored in the same SAP system. Thus the final state of the service operation is correlated with the service ticket, and the service operation is retrievably stored.

In accordance with a further feature of the invention, an error message may be created if the correlation between the diagnostic entry and the service ticket fails. In the course of the service tracking process, a service technician may erroneously enter diagnostic data under a wrong SAP number, thus causing an incorrect allocation to a different service ticket or to a non-existent service ticket. In such a case, the service tracking system will generate an error message because a correct allocation of the diagnosis to the service ticket is impossible. Once an error message has appeared, the service technician is prompted to input correction values to correct the information in the service tracking system using an input device such as a keyboard to ensure that the completed service ticket is successfully filed in the SAP system.

The correlation between the operating data from the knowledge base and the service ticket in the service tracking system may be made in a common data file or by providing a link to the knowledge base in the service ticket of the service tracking system. These are only two possible examples of ways of linking the data required for the service operation. In addition, the link may include a user identification of an active user of the service tracking system and a serial number of the machine to be serviced. In this case, the link, which is a URL, contains the name of the service technician and the serial number of the machine currently to be serviced. Such a conclusive naming is beneficial because it prevents the service staff from confusing corresponding links.

In accordance with a further feature, the link may contain a service request number of the service tracking system such as the SAP number of the service ticket. Once the link is accessed, the data transfer from the knowledge base may be achieved using known database interfaces. This way the service staff can access the data of the knowledge base from the remote service computer via the service tracking system.

Other features which are considered as characteristic for the invention are set forth in the appended claims.

Although the invention is illustrated and described herein as embodied in a service tracking system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a diagrammatic representation of a remote service computer displaying the tracking of a service operation in a SAP system according to the invention.

### DETAILED DESCRIPTION OF THE INVENTION

Referring now to the single FIGURE of the drawing in detail, there is diagrammatically illustrated a service tracking system in the form of an SAP system 1. Different service tracking operations run on the system. The service operation is initiated by a customer who makes a service request on a phone 2. Alternatively, the service request may be made via the Internet through an online connection initiated by the customer, or by email. The SAP system 1 is part of a remote service computer 4 which additionally includes a knowledge base 5. The task of the knowledge base 5 is to obtain and store operating data of a printing press 3 located at a customer site, for instance via the Internet. The operating data that are transferred in the process may be transferred in a common format such as XML. They in particular contain error codes and malfunction reports for the press 3. However, it is likewise possible for a service technician to obtain this information in an interview with the customer on the phone. The service technician would then proceed to enter the data of the press 3 into the knowledge database 5. Moreover the SAP system has an interface for entering data to generate a service ticket that has an SAP number. Thus a service technician who has received a service request on the phone 2 may likewise generate a corresponding service ticket in the SAP system 1 to initiate a service operation.

Once such an SAP service ticket with a corresponding number has been generated, a link is created between the SAP system 1 and the knowledge base 5. The knowledge base 5 contains the entire diagnostic history of the machine in question and the requested operating data. Based on the data gained in this way, a diagnosis can now be made. The result of the diagnostic process is in turn stored in the knowledge base 5. Due to a link in the SAP ticket, this result is likewise accessible to the service team at any time via a user interface 6. For this purpose, the service ticket in the SAP system 1 provides a link to access the knowledge base 5. This link is a URL such as http://<knox2.0server>:<port>/sap2knox2.0jsp?user=bgvta2vtxyi%3d&serialno=123 456&serviceno=56377829&sapsystem=P00, which may contain parameters such as user ID of the active service team, serial number of the press 3 referenced in the service ticket, and SAP ticket number. If there is more than one SAP system, the URL may additionally contain an identification of the SAP system that generated the corresponding service ticket. Thus the link with the URL contains the important connection between the information about the press 3 in question, the service team working on the problem, and the SAP ticket. In the context, the URL is initially transmitted to the knowledge base 5 in plain text. The service team parameter, however, is coded.

When a member of the service team selects the link in the SAP ticket on the screen 6, a new browser window will open to provide access to the data stored in the knowledge base 5. The name of the service technician will be used as the author of a new diagnosis, whereas the serial number of the press 3 is used to automatically identify the press 3 in the knowledge base 5. Then the service technician in front of the screen 6 selects the field of knowledge of the relevant press 3 to be serviced and starts a new diagnostic process or opens an existing diagnosis from the diagnostic history of the press 3 to be serviced. The diagnostic history may be displayed automatically upon transferring the serial number of the press 3. In the service ticket, the boxes for the parameters of service ticket number and pertinent SAP system 1 are initialized by the SAP system 1 and cannot be changed by the service team in front of the screen 6.

The service team then carries out the diagnostic process and tries to solve the identified problem. If no satisfactory solution can be found, this fact is entered into the SAP ticket and stored in the SAP system. If a satisfactory solution is found, the diagnostic process is completed. In this case, either no entry can be made in the SAP system, thus terminating the service tracking operation, or an entry is made in the SAP system. In the latter case the diagnosis is transferred from the knowledge base 5 to the SAP system 1, where it is stored so that each SAP ticket is assigned the corresponding successful diagnosis. If the transfer to the SAP system is successful, the process is completed and the case closed.

However, if the transfer to the SAP system 1 fails, an error message is generated prompting the service team to correct the number of the SAP ticket where necessary to ensure successful storage of the transferred diagnosis. The transfer of the diagnostic data from the knowledge base 5 to the SAP system occurs automatically as the data having the status “diagnosis pending” or “temporary error” in the knowledge base are cyclically requested via a database interface. Upon transfer to the SAP system 1, a result status is written into the status box or, in case of an error, a status description is written into the “error text” field. The status may basically have the following values: diagnosis pending, diagnosis completed, error message, data transfer to SAP1 and temporary error if the storing of the data following the data transfer to the SAP system 1 has failed because the service ticket was simultaneously opened by another user. In these cases the datasets that have one of these statuses will be transferred again in the course of the next cyclical request.

A fundamental provision is that no datasets in the SAP system 1 are deleted. Thus the information can be used for reports and error analyses. Faulty datasets contained in the table may be corrected by an administrator and may be reset to a status “service operation pending”. The corrected dataset may then be transferred to the SAP system 1 in the course of the following cyclical request.

The knowledge base 5 transfers the diagnostic data to the table in the SAP database 1 via a database trigger on a non-illustrated log space of the server in the remote service computer 4. The diagnoses marked for transfer to the SAP system are written into the log space of the table immediately upon insertion. Upon insertion of a diagnosis into the table, the status is changed to “diagnosis pending”, so that the relevant diagnoses will immediately be available for the following transfer operation to the SAP system 1.

Thus the data stored in the knowledge base 5 are continuously synchronized with the SAP system 1 and links between the SAP ticket and its number are maintained to ensure continuous tracking of the service operation.

1. A method of servicing machinery in the graphic arts industry, which comprises the steps of:
receiving, via at least one remote service computer, a service request for a machine through a first information channel and generating a service ticket from the service request;
receiving, at the remote service computer, operating data of the machine via a second information channel;
linking the operating data to the service ticket in the remote service computer resulting in linked data; and
subjecting the linked data to a diagnostic fault-finding process by means of the remote service computer.

2. The method according to claim 1, which further comprises:
storing the service ticket in a service tracking system; and
once a diagnosis has been made or the service ticket has been successfully processed, creating a diagnostic entry containing a link to the service ticket in the service tracking system.

3. The method according to claim 2, which further comprises generating an error message when a linking of the diagnostic entry with the service ticket fails.

4. The method according to claim 2, which further comprises:
storing the service request received by the remote service terminal via the first Information channel in the service tracking system; and
storing the operating data of the machine received via the second information channel in a different database.

5. The method according to claim 4, wherein data from the service tracking system and associated data from the different database are linked with each other in the service ticket.

6. The method according to claim 3, which further comprises after a creation of an error message, inputting correction values using an input device to correct entries in the service tracking system.

7. The method according to claim 4, which further comprises establishing a link between the different database and the service tracking system by providing a link to the different database in the service tracking system.

8. The method according to claim 7, wherein the link contains a user ID of an active user of the service tracking system and a serial number of the machine to be serviced.

9. The method according to claim 8, wherein the link additionally includes a service request number of the service tracking system.

10. The method according to claim 8, which further comprises carrying out a data transfer from the different database to the service tracking system via a database interface.
